(19) United States
(12) Patent Application Publication
(10) Pub. No.: US 2018/0068473 A1
(43) Pub. Date: Mar. 8, 2018

(54) IMAGE FUSION TECHNIQUES

(71) Applicant: Apple Inc., Cupertino, CA (US)

(72) Inventors: Marius Tico, Mountain View, CA (US); Lech J. Szumilas, Cupertino, CA (US); Xiaoxing Li, Cupertino, CA (US); Paul M. Hubel, Cupertino, CA (US); Todd S. Sachs, Palo Alto, CA (US)

(21) Appl. No.: 15/257,855

(22) Filed: Sep. 6, 2016

(51) Int. Cl. G06T 11/60; G06T 7/00; G06T 3/00; G06K 9/32; H04N 5/247; H04N 5/262

(52) U.S. Cl. CPC G06T 11/60; G06T 7/0024; G06T 3/0093; G06T 7/0081; G06T 7/0097; G06T 2207/20144; H04N 5/247; H04N 5/2621; G06T 2207/10004; G06T 2207/20221; G06K 9/3233

(57) ABSTRACT

Image fusion techniques hide artifacts that can arise at seams between regions of different image quality. According to these techniques, image registration may be performed on multiple images having at least a portion of image content in common. A first image may be warped to a spatial domain of a second image based on the image registration. A fused image may be generated from a blend of the warped first image and the second image, wherein relative contributions of the warped first image and the second image are weighted according to a distribution pattern based on a size of a smaller of the pair of images. In this manner, contributions of the different images vary at seams that otherwise would appear.

### BACKGROUND

The present disclosure relates to image processing techniques and, in particular, to techniques to merge image content from related cameras into a single output image.

Image fusion techniques involve merger of image content from multiple source images into a common image. Typically, such techniques involve two stages of operation. In a first stage, called “registration,” a comparison is made between the images to identify locations of common content in the source images. In a second stage, a “fusion” stage, the content of the images are merged into a final image. Typically, the final image is more informative than any of the source images.

Image fusion techniques can have consequences, however, particularly in the realm of consumer photography. Scenarios may arise where a final image has different regions for which different numbers of the source images contribute content. For example, a first region of the final image may have content that is derived from the full number of source images available and, consequently, will have a first level of image quality associated with it. A second region of the final image may have content that is derived from a smaller number of source images, possibly a single source image, and it will have a different, lower level of image quality. These different regions may become apparent to viewers of the final image and may be perceived as annoying artifacts, which diminishes the subjective image quality of the final image, taken as a whole.

The inventors perceive a need in the art for an image fusion technique that reduces perceptible artifacts in images that are developed from multiple source images.

### BRIEF DESCRIPTION OF THE DRAWINGS

FIG. 1 illustrates a device according to an embodiment of the present disclosure.

FIG. 2 illustrates a method according to an embodiment of the present disclosure.

FIG. 3 illustrates processing of exemplary image data that may occur during operation of the foregoing embodiments.

FIG. 4 illustrates a method according to an embodiment of the present disclosure.

FIG. 5 illustrates a fusion unit according to an embodiment of the present disclosure.

FIG. 6 illustrates a layer fusion unit according to an embodiment of the present disclosure.

FIG. 7 illustrates an exemplary computer system suitable for use with embodiments of the present disclosure.

### DETAILED DESCRIPTION

Embodiments of the present disclosure provide image fusion techniques that hide artifacts that can arise at seams between regions of different image quality. According to these techniques, image registration may be performed on multiple images having at least a portion of image content in common. A first image may be warped to a spatial domain of a second image based on the image registration. A fused image may be generated from a blend of the warped first image and the second image, wherein relative contributions of the warped first image and the second image are weighted according to a distribution pattern based on a size of a smaller of the pair of images. In this manner, contributions of the different images vary at seams that otherwise would appear.

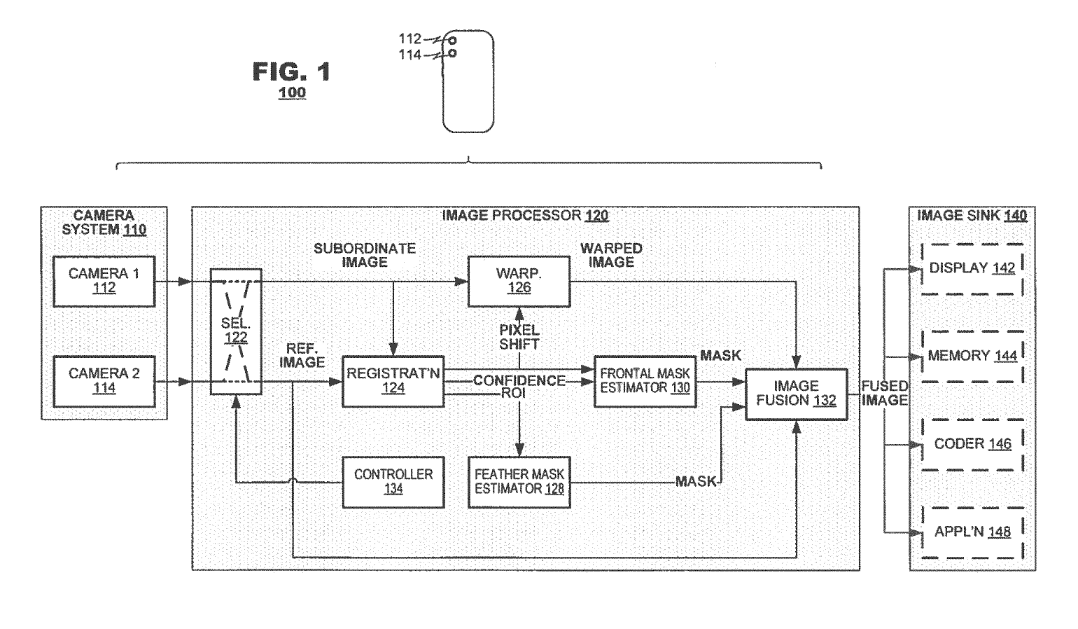

FIG. 1 illustrates a device 100 according to an embodiment of the present disclosure. The device may include a camera system 110 and an image processor 120. The camera system 110 may have a pair of cameras 112, 114 each mounted within the device so that the fields of view of the cameras 112, 114 overlap each other in some manner. The cameras 112, 114 may have different characteristics, such as different pixel counts, different zoom properties, different focal lengths or other properties, which may create differences in the fields of view represented by image data output by the two cameras 112, 114. Owing to these different operational properties, the different cameras 112, 114 may be better suited to different types of image capture operations. For example, one camera 114 (called a “wide” camera, for convenience) may have a relatively wide zoom as compared to the other camera 112, and may be better suited to capture images at shorter distances from the device 100. The other camera 112 (called a “tele” camera, for convenience) may have a larger level of zoom and/or higher pixel counts, and it may be better suited to capture images at larger distances from the device 100. For some capture events, for example, capture of images at intermediate distances from the large distances of the wide camera 114 and the short distance of the tele camera 112, image content can be derived from a merger of image data from the tele and wide cameras 112, 114 that has higher image quality than the images output directly from these cameras.

The image processor 120 may include a selector 122, a registration unit 124, a warping unit 126, a feather mask estimator 128, a frontal mask estimator 130, and an image fusion unit 132, all operating under control of a controller 134. The selector 122 may select an image from one of the cameras 112, 114 to be a “reference image” and an image from another one of the cameras 112, 114 to be a “subordinate image.” The registration unit 124 may estimate skew between content of the subordinate image and content of the reference image. The registration unit 124 may output data representing spatial shifts of each pixel of the subordinate image that align with a counterpart pixel in the reference image. The registration unit 124 also may output confidence scores for the pixels representing an estimated confidence that the registration unit 124 found a correct counterpart pixel in the reference image. The registration unit 124 also may search for image content from either the reference image or the subordinate image that represents a region of interest (“ROI”) and, if such ROIs are detected, it may output data identifying location(s) in the image where such ROIs were identified.

The warp unit 126 may deform content of the subordinate image according to the pixel shifts identified by the registration unit 124. The warp unit 126 may output a warped version of the subordinate image that has been deformed to align pixels of the subordinate image to their detected counterparts in the reference image.

The feather mask estimator 128 and the frontal mask estimator 130 may develop filter masks for use in blending image content of the warped image and the reference image. The feather mask estimator 128 may generate a mask based on differences in the fields of view of images, with accommodations made for any ROIs that are detected in the image data. The frontal mask estimator 130 may generate a mask based on an estimate of foreground content present in the image data.

The image fusion unit 132 may merge content of the reference image and the subordinate image. Contributions of the images may vary according to weights that are derived from the masks generated by the feather mask estimator 128 and the frontal mask estimator 130. The image fusion unit 132 may operate according to transform-domain fusion techniques and/or spatial-domain fusion techniques. Exemplary transform domain fusion techniques include Laplacian pyramid-based techniques, curvelet transform-based techniques, discrete wavelet transform-based techniques, and the like. Exemplary spatial domain transform techniques include weighted averaging, Brovey method and principal component analysis techniques. The image fusion unit 132 may generate a final fused image from the reference image, the subordinate image and the masks.

The image processor 120 may output the fused images to other image “sink” components 140 within device 100. For example fused images may be output to a display 142 or stored in memory 144 of the device 100. The fused images may be output to a coder 146 for compression and, ultimately, transmission to another device (not shown). The images also may be consumed by an application 148 that executes on the device 100, such as an image editor or a gaming application.

In an embodiment, the image processor 120 may be provided as a processing device that is separate from a central processing unit (colloquially, a “CPU”) (not shown) of the device 100. In this manner, the image processor 120 may offload from the CPU processing tasks associated with image processing, such as the image fusion tasks described herein. This architecture may free resources on the CPU for other processing tasks, such as application execution.

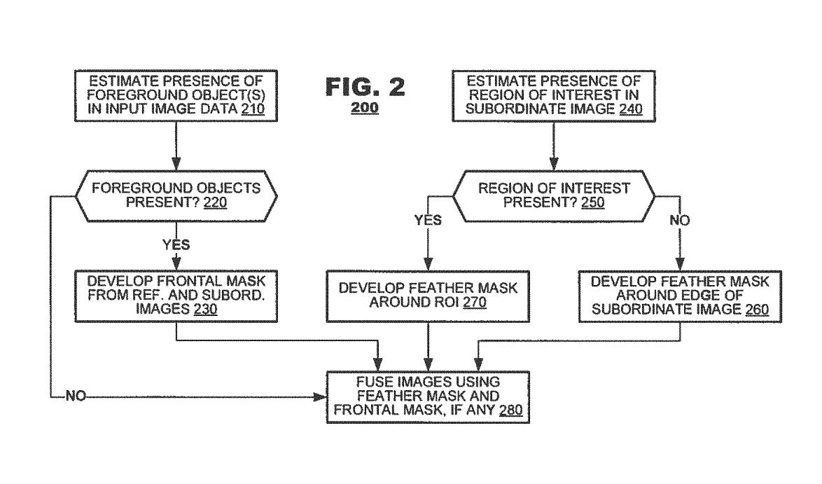

In an embodiment, the camera 110 and image processor 120 may be provided within a processing device 100, such as a smartphone, a tablet computer, a laptop computer, a desktop computer, a portable media player, or the like. FIG. 2 illustrates a method 200 according to an embodiment of the present disclosure. The method 200 may estimate whether foreground objects are present within image data (box 210), either the reference image or the subordinate image. If foreground objects are detected (box 220), the method may develop a frontal mask from a comparison of the reference image and the subordinate images (box 230). If no foreground objects are detected (box 220), development of the frontal mask may be omitted.

The method 200 also may estimate whether a region of interest is present the subordinate image (box 240). If no region of interest is present (box 250), the method 200 may develop a feather mask according to spatial correspondence between the subordinate image and the reference image (box 260). If a region of interest is present (box 250), the method 200 may develop a feather mask according to a spatial location of the region of interest (box 270). The method 200 may fuse the subordinate image and the reference image using the feather mask and the frontal mask, if any, that are developed in boxes 230 and 260 or 270 (box 280).

Estimation of foreground content (box 210) may occur in a variety of ways. Foreground content may be identified from pixel shift data output by the registration unit 124 (FIG. 1); pixels that correspond to foreground content in image data typically have larger disparities (i.e. shifts along the epipolar line) associated with them than pixels that correspond to background content in image data. In an embodiment, the pixel shift data may be augmented by depth estimates that are applied to image data. Depth estimation, for example, may be performed based on detection relative movement of image content across a temporally contiguous sequence of images. For example, content in a foreground of an image tends to exhibit larger overall motion in image content than background content of the same image, due to movement of the cameras as they perform image capture. Depth estimation also may be performed from an assessment of an amount of blur in image content. For example, image content in focus may be identified as located at a depth corresponding to the focus range of the camera that performs image capture whereas image content that is out of focus may be identified as being located at other depths.

ROI identification (box 240) may occur in a variety of ways. In a first embodiment, ROI identification may be performed based on face recognition processes or body recognition processes applied to the image content. ROI identification may be performed from an identification of images having predetermined coloration, for example, colors that are previously registered as corresponding to skin tones. Alternatively, ROI identification may be performed based on relative movement of image content across a temporally contiguous sequence of images. For example, content in a foreground of an image tends to exhibit larger overall motion in image content than background content of the same image, whether due to movement of the object itself during image capture or due to movement of a camera that performs the image capture.

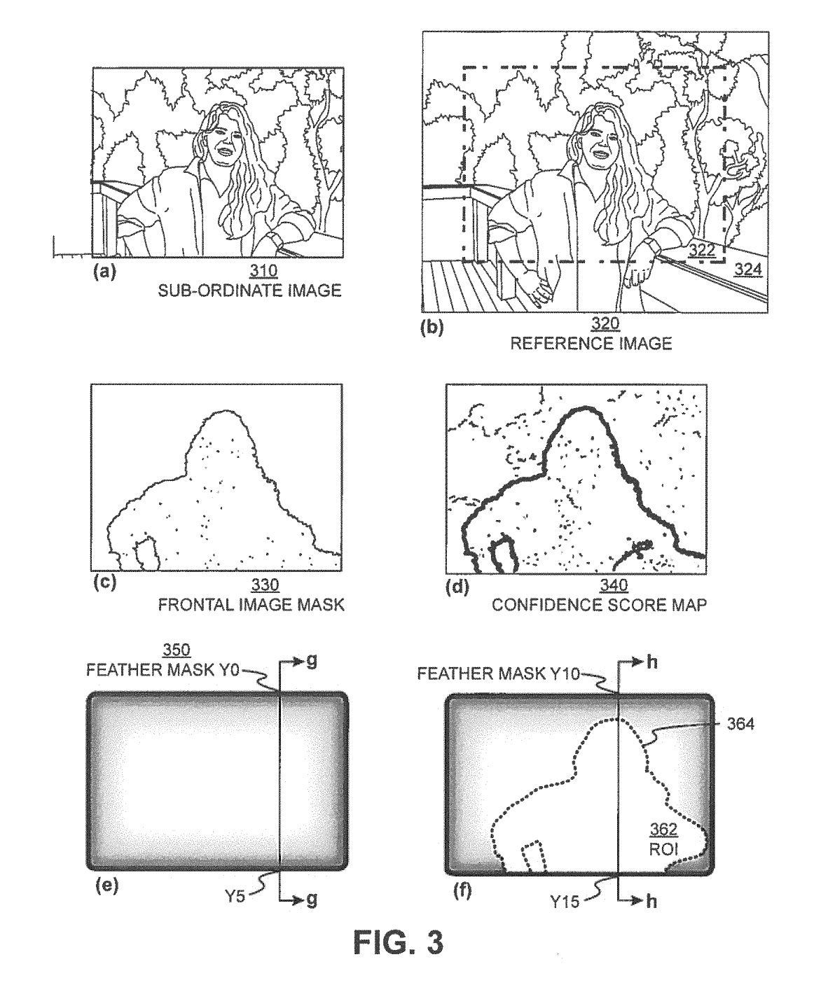

FIG. 3 illustrates processing of exemplary image data that may occur during operation of the foregoing embodiments. FIGS. 3(a) and 3(b) illustrate an exemplary sub-ordinate image 310 and exemplary reference image 320 that may be captured by a pair of cameras. As can be seen from these figures, the field of view captured by the sub-ordinate image 310 is subsumed within the field of view of the reference image 320, denoted by the rectangle 322. Image content of the sub-ordinate image 310 need not be identical to image content of the reference image 320, as described below.

The registration unit 124 (FIG. 1) may compare image content of the sub-ordinate and reference images 310, 320 and may determine, for each pixel in the sub-ordinate image 310, a shift to be imposed on the pixel to align the respective pixel to its counter-part pixel in the reference image 320.

FIG. 3(c) illustrates a frontal image mask 330 that may be derived for the sub-ordinate image. As discussed, the frontal image mask 330 may be derived from pixel shift data developed from image registration and/or depth estimation performed on one or more of the images 310, 320. The frontal image mask 330 may include data provided at each pixel location (a “map”) representing a weight to be assigned to the respective pixel. In the representation shown in FIG. 3(c), light regions represent relatively high weightings assigned to the pixel locations within those regions and dark regions represent relatively low weightings assigned to the pixel locations within those regions. These weights may represent contribution of corresponding image content from the sub-ordinate image 310 as the fused image is generated.

FIG. 3(d) illustrates another map 340 of confidence scores that may be assigned by a registration unit based on comparison of image data in the sub-ordinate image 310 and the reference image 320. In the representation shown in FIG. 3(d), light regions represent spatial areas where registration between pixels of the sub-ordinate and reference images 310, 320 was identified at a relatively high level of confidence and dark regions represent spatial areas where registration between pixels of the sub-ordinate and reference images 310, 320 was identified at a low level of confidence.

As illustrated in FIG. 3(d), low confidence scores often arise in image regions representing a transition between foreground image content and background image content. Owing to various operational differences between the cameras that capture the sub-ordinate and reference images 310, 320—for example, their optical properties, the locations where they are mounted within the device 100 (FIG. 1), their orientation, and the like—it can occur that pixel content that appears as background content in one image is obscured by foreground image content in another image. In that case, it may occur that background pixel from one image has no counterpart in the other image. Low confidence scores may be assigned in these and other circumstances where a registration unit cannot identify a pixel's counterpart in its counterpart image.

FIG. 3(e) illustrates a feather mask 350 according to an embodiment. In the representation shown in FIG. 3(e), light regions represent pixel locations to which relatively high weightings have been assigned and darker regions represent pixel locations to which lower weightings have been assigned. These weights may represent contribution of corresponding image content from the sub-ordinate image 310 as the fused image is generated.

In the embodiment of FIG. 3(e), the distribution of weights may be determined based on spatial orientation of the sub-ordinate image. As illustrated, pixel locations toward a center of the sub-ordinate image 310 may have the highest weights assigned to them. Pixel locations toward edges of the sub-ordinate image 310 may have lower weights assigned to them. Pixel locations at the edge of the sub-ordinate image 310 may have the lowest weights assigned to them.

In implementation, the distribution of weights may be tailored to take advantage of relative performance characteristics of the two cameras and to avoid abrupt discontinuities that otherwise might arise due to a “brute force” merger of images. Consider, for example, an implementation using a wide camera and a tele camera in which the wide camera has a relatively larger field of view than the tele camera and in which the tele camera has a relatively higher pixel density. In this example, weights may be assigned to tele camera data to preserve high levels of detail that are available in the image data from the tele camera. Weights may diminish at edges of the tele camera data to avoid abrupt discontinuities at edge regions where the tele camera data cannot contribute to a fused image. For example, as illustrated in FIG. 3(b), fused image data can be generated from a merger of reference image data and sub-ordinate image data in the region 322 but fused image data can be generated only from reference image data in a region 324 outside of region 322, owing to the wide camera's larger field of view. Application of diminishing weights as illustrated in FIG. 3(e) can avoid discontinuities in the fused image even though the fused image (not shown) will have higher resolution content in a region co-located with region 322 and lower resolution content in a region corresponding to region 324.

FIG. 3(f) illustrates a feather mask 360 according to another embodiment. As with the representation shown in FIG. 3(e), light regions represent pixel locations to which relatively high weightings have been assigned and darker regions represent pixel locations to which lower weightings have been assigned. These weights may represent contribution of corresponding image content from the sub-ordinate image 310 as the fused image is generated.

In the embodiment of FIG. 3(f), the distribution of weights may be altered from a default distribution, such as the distribution illustrated in FIG. 3(e), when a region of interest is identified as present in image content. FIG. 3(f) illustrates an ROI 362 overlaid over the feather mask 360. In this example, as shown toward the bottom and right-hand side of the feature mask 360, the ROI 362 occupies regions that by default would have relatively low weights assigned to them. In an embodiment, the weight distribution may be altered to assign higher weights to pixel locations occupied by the ROI 362. In circumstances where an ROI 362 extends to the edge of a sub-ordinate image 310, then diminishing weights may be applied to the edge data of the ROI 362. Typically, the distribution of diminishing weights to an ROI 362 will be confined to a shorter depth inwardly from the edge of the feather mask 360 than for non-ROI portions of the sub-ordinate image 310.

FIGS. 3(g) and 3(h) illustrate exemplary weights that may be assigned to sub-ordinate image 310 according to the examples of FIGS. 3(e) and 3(f), respectively. In FIG. 3(g), graph 372 illustrates weights that may be assigned to image data along line g-g in FIG. 3(e). In FIG. 3(h), graph 376 illustrates weights that may be assigned to image data along line h-h in FIG. 3(f). Both examples illustrate weight values that increase from a minimum value at an image edge in a piece-wise linear fashion to a maximum value. In FIG. 3(g), the weight value starts at the minimum value at Y0, increases at a first rate from Y0 to Y1, then increases at a second rate from Y1 to Y2 until the maximum value is reached. Similarly, in FIG. 3(h), the weight value starts at the minimum value at Y10, increases at a first rate from Y10 to Y11, then increases at a second rate from Y11 to Y12 until the maximum value is reached. As compared to the weight distribution from Y0 to Y2 in FIG. 3(g), the distribution of weights from Y10-Y12 in FIG. 3(h) is accelerated due to the presence of the ROI; the distances from Y10 to Y11 to Y12 are shorter than the distances from Y0 to Y1 to Y2.

Similarly, in FIG. 3(g), the weight value decreases from the maximum value in piece-wise linear fashion from Y3 to Y5. It decreases at one rate from Y3 to Y4, then decreases at another rate from Y4 to Y5 until the minimum value is reached. In FIG. 3(h), the weight value starts at the maximum value at Y13, decreases from Y13 to Y14 and decreases at a different rate from Y14 to Y15 until the minimum value is reached. As compared to the weight distribution from Y3 to Y5 in FIG. 3(g), the distribution of weights from Y13-Y15 in FIG. 3(h) also is accelerated due to the presence of the ROI 362; the distances from Y13 to Y14 to Y15 are shorter than the distances from Y3 to Y4 to Y5.

Weights also may be assigned to reference image data based on the weights that are assigned to the sub-ordinate image data. FIGS. 3(g) and 3(h) illustrate graphs 374 and 378, respectively, that illustrate exemplary distribution of weights assigned to the reference image data. Typically, the weights assigned to the reference image data may be complementary to those assigned to the sub-ordinate image data.

The illustrations of FIG. 3 provide one set of exemplary weight assignments that may be applied to image data. Although linear and piece-wise linear weight distributions are illustrated in FIG. 3, the principles of the present disclosure apply to other distributions that may be convenient, such as curved, curvilinear, exponential, and/or asymptotic distributions. As indicated, it is expected that system designers will develop weight distribution patterns that are tailored to the relative performance advantages presented by the cameras used in their systems.

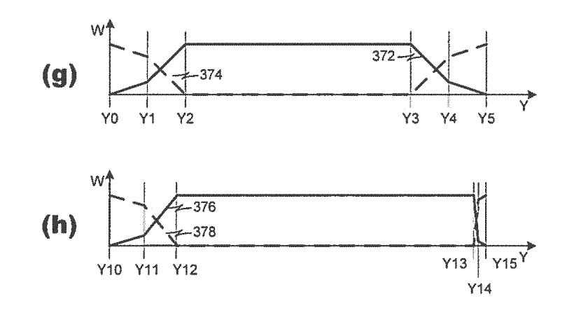

FIG. 4 illustrates a method of performing image registration, according to an embodiment of the present disclosure. The method 400 may perform frequency decomposition on the reference image and the sub-ordinate image according to a pyramid having a predetermined number of levels (box 410). For example, there may be L levels with the first level having the highest resolution (i.e. width, height) and the L^{th} level having the lowest resolution (i.e. width/2^{L}, height/2^{L}). The method 400 also may set a shift map (SX, SY) to zero (box 420). Thereafter, the image registration process may traverse each level in the pyramid, starting with the lowest resolution level.

At each level i, the method 400 may scale a shift map (SX, SY)ᵢ₋₁ from a prior level according to the resolution of the current level and the shift values within the map may be multiplied accordingly (box 430). For example, for a dyadic pyramid, shift map values SXᵢ and SYᵢ may be calculated as SXᵢ=2*rescale(SXᵢ₋₁), SYᵢ=2*rescale(SYᵢ₋₁). Then, for each pixel location (x,y) in the reference image at the current level, the method 400 may search for a match between the reference image level pixel and a pixel in the subordinate image level (box 440). The method 400 may update the shift map value at the (x,y) pixel based on the best matching pixel found in the subordinate image level. This method 400 may operate at each level either until the final pyramid level is reached or until the process reaches a predetermined stopping point, which may be set, for example, to reduce computational load.

Searching between the reference image level and the sub-ordinate image level (box 440) may occur in a variety of ways. In one embodiment, the search may be centered about a co-located pixel location in the subordinate image level x+sx and four positions corresponding to one pixel shift up, down, left and right, i.e. (x+sx+1, y+sy), (x+sx−1, y+sy), y+sy+1), (x+sx, y+sy−1). The search may be conducted between luma component values among pixels. In one implementation, versions of the subordinate image level may be generated by warping the subordinate image level in each of the five candidate directions, then calculating pixel-wise differences between luma values of the reference image level and each of the warped subordinate image levels. Five difference images may be generated, each corresponding to a respective difference calculation. The difference images may be filtered, if desired, to cope with noise. Finally, at each pixel location, the difference value having the lowest magnitude may be taken as the best match. The method 400 may update the pixel shift value at each pixel's location based on the shift that generates the best-matching difference value.

In an embodiment, once the shift map is generated, confidence scores may be calculated for each pixel based on a comparison of the shift value of the pixel and the shift values of neighboring pixels (box 460). For example, confidence scores may be calculated by determining the overall direction of shift in a predetermined region surrounding a pixel. If the pixel's shift value is generally similar to the shift values within the region, then the pixel may be assigned a high confidence score. If the pixel's shift value is dissimilar to the shift values within the region, then the pixel may be assigned a low confidence score. Overall shift values for a region may be derived by averaging or weighted averaging shift values of other pixel locations within the region.

Following image registration, the sub-ordinate image may be warped according to the shift map (box 470). The location of each pixel in the subordinate image may be relocated according to the shift values in the shift map.

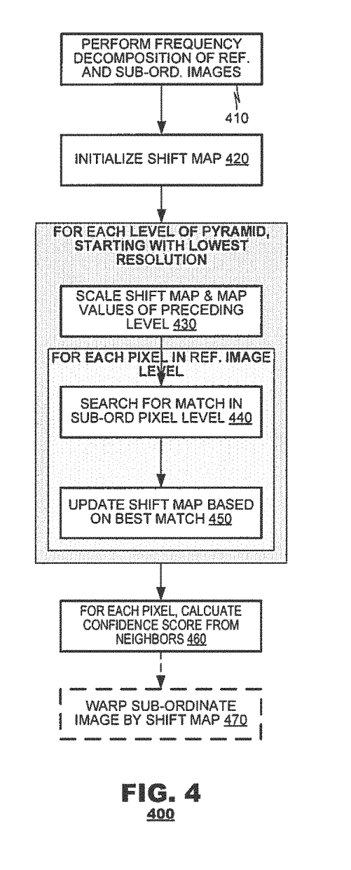

FIG. 5 illustrates a fusion unit 500 according to an embodiment of the present disclosure. The fusion unit may include a plurality of frequency decomposition units 510-514, 520-524, . . . , 530-534, a mixer 540, a plurality of layer fusion units 550-556 and a merger unit 560. The frequency decomposition units 510-514, 520-524, . . . , 530-534 may be arranged as a plurality of layers, each layer generating filtered versions of the data input to it. A first chain of frequency decomposition units 510, 520, . . . , 530 may be provided to filter reference image data, a second chain of frequency decomposition units 512, 522, . . . , 532 may be provided to filter warped sub-ordinate data, and a third chain of frequency decomposition units 514, 524, . . . , 534 may be provided to filter mask data. Each layer of the frequency decomposition units 510-514, 520-524, . . . , 530-534 may have a layer fusion unit 550, 552, 554, . . . 556 associated with it.

The mixer 540 may take the frontal mask data and feather mask data as inputs. The mixer 540 may output data representing a pixel-wise merger of data from the two masks. In embodiments where high weights are given high numerical values, the mixer 540 may multiply the weight values at each pixel location or, alternatively, take the maximum weight value at each location as output data for that pixel location. An output from the mixer 540 may be input to the first layer frequency decomposition unit 514 for the mask data.

The layer fusion units 550-556 may output image data of their associated layers. Thus, the layer fusion unit 550 may be associated with the highest frequency data from the reference image and the warped sub-ordinate image (no frequency decomposition), a second layer fusion unit 552 may be associated with a first layer of frequency decomposition, and a third layer fusion unit 554 may be associated with a second layer of frequency decomposition. A final layer fusion unit 556 may be associated with a final layer of frequency decomposition. Each layer fusion unit 550, 552, 554, . . . 556 may receive the reference image layer data, the subordinate image layer data and the weight layer data of its respective layer. Output data from the layer fusion units 550-556 may be input to the merger unit 560.

Each layer fusion unit 550, 552, 554, . . . 556 may determine whether to fuse the reference image layer data and the subordinate image layer data based on a degree of similarity between the reference image layer data and the subordinate image layer data at each pixel location. If co-located pixels from the reference image layer data and the subordinate image layer data have similar values, the layer fusion unit (say, unit 552) may fuse the pixel values. If the co-located pixels do not have similar values, the layer fusion unit 552 may not fuse them but rather output a pixel value taken from the reference image layer data.

The merger unit 570 may combine the data output from the layer fusion units 550-556 into a fused image. The merger unit 570 may scale the image data of the various layers to a common resolution, then add the pixel values at each location. Alternatively, the merger unit 570 may weight the layers' data further according to a hierarchy among the layers. For example, in applications where sub-ordinate image data is expected to have higher resolution than reference image data, correspondingly higher weights may be assigned to output data from layer fusion units 550-552 associated with higher frequency layers as compared to layer fusion units 554-556 associated with lower frequency layers. In application, system designers may tailor individual weights to fit their application needs.

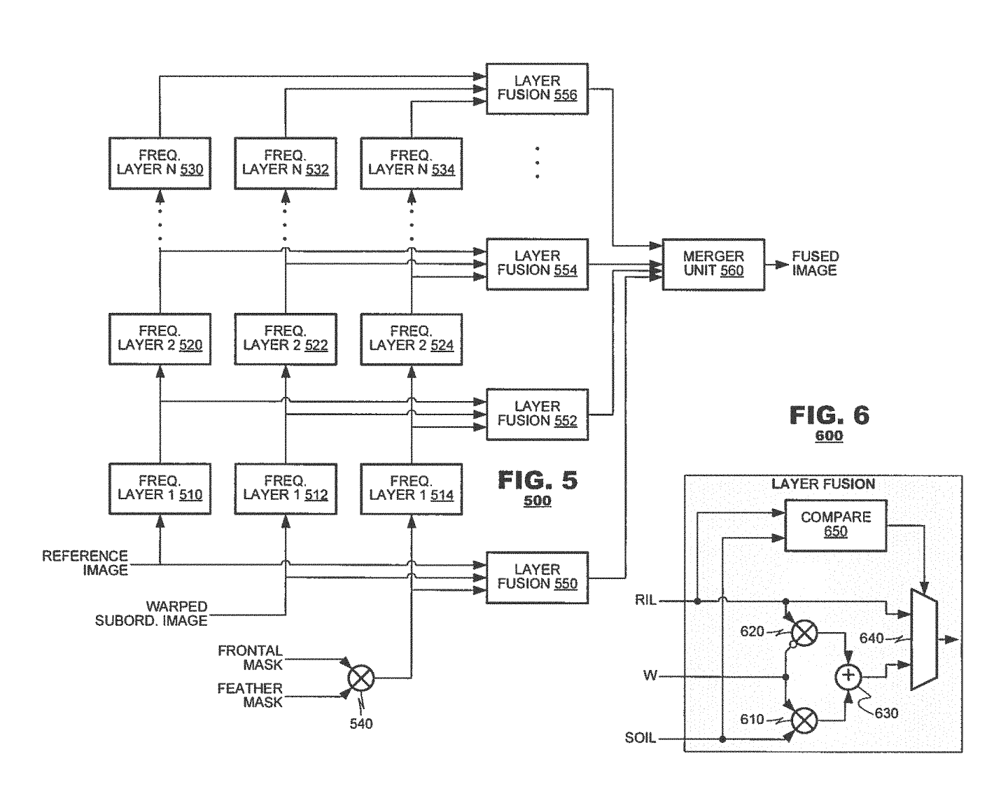

FIG. 6 illustrates a layer fusion unit 600 according to an embodiment of the present disclosure. The layer fusion unit 600 may include a pair of mixers 610, 620, an adder 630, a selector 640 and a comparison unit 650. The mixers 610, 620 may receive filtered mask data W from an associated frequency decomposition unit. The filtered mask data may be applied to each mixer 610, 620 in complementary fashion. When a relatively high value is input to a first mixer 610, a relatively low value may be input to the second mixer 620 (denoted by the symbol “∘” in FIG. 6). For example, in a system using a normalized weight value W (1>W>0), the value W may be input to the first mixer 610 and the value 1−α may be input to the other mixer 620.

The first mixer 610 in the layer fusion unit 600 may receive filtered data from a frequency decomposition unit associated with the sub-ordinate image chain and a second mixer 620 may receive filtered data from the frequency decomposition unit associated with the reference image chain. Thus, the mixers 610, 620 may apply complementary weights to the reference image data and the sub-ordinate image data of the layer. The adder 630 may generate pixel-wise sums of the image data input to it by the mixers 610, 620. In this manner, the adder 630 may generate fused image data at each pixel location.

The selector 640 may have inputs connected to the adder 630 and to the reference image data that is input to the layer fusion unit 600. A control input may be connected to the comparison unit 650. The selector 640 may receive control signals from the comparison unit 650 that, for each pixel, cause the selector 640 to output either a pixel value received from the adder 630 or the pixel value in the reference image layer data. The selector's output may be output from the layer fusion unit 600.

As indicated, the layer fusion unit 600 may determine whether to fuse the reference image layer data and the subordinate image layer data based on a degree of similarity between the reference image layer data and the subordinate image layer data at each pixel location. The comparison unit 650 may determine a level of similarity between pixels in the reference and the subordinate image level data. In an embodiment, the comparison unit 650 may make its determination based on a color difference and/or a local high frequency difference (e.g. gradient difference) between the pixel signals. If these differences are lower than a predetermined threshold then the corresponding pixels are considered similar and the comparison unit 650 causes the adder's output to be output via the selector 650 (the image data is fused at the pixel location).

In an embodiment, the comparison threshold may be set based on an estimate of a local noise level. The noise level may be set, for example, based properties of the cameras 112, 114 (FIG. 1) or based on properties of the image capture event (e.g., scene brightness). In an embodiment, the threshold may be derived from a test protocol involving multiple test images captured with each camera. Different thresholds may be set for different pixel locations, and they may be stored in a lookup table (not shown).

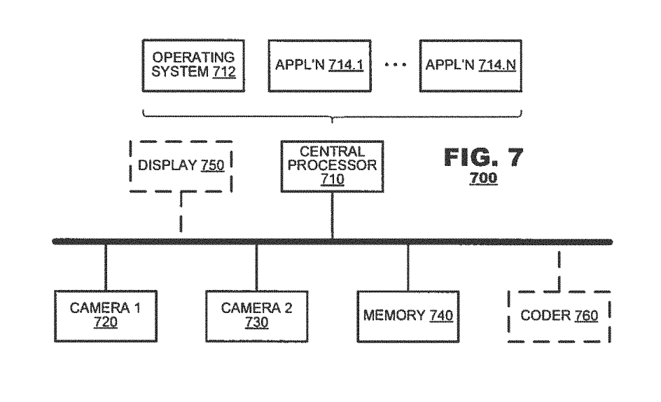

In another embodiment, the image fusion techniques described herein may be performed by a central processor of a computer system. FIG. 7 illustrates an exemplary computer system 700 that may perform such techniques. The computer system 700 may include a central processor 710, a pair of cameras 720, 730 and a memory 740 provided in communication with one another. The cameras 720, 730 may perform image capture according to the techniques described hereinabove and may store captured image data in the memory 740. Optionally, the device also may include a display 750 and a coder 760 as desired.

The central processor 710 may read and execute various program instructions stored in the memory 740 that define an operating system 712 of the system 700 and various applications 714.1-714.N. The program instructions may perform image fusion according to the techniques described herein. As it executes those program instructions, the central processor 5710 may read from the memory 740, image data created by the cameras 720, 730 and it may perform image registration operations, image warp operations, frontal and feather mask generation, and image fusion as described hereinabove.

As indicated, the memory 40 may store program instructions that, when executed, cause the processor to perform the image fusion techniques described hereinabove. The memory 740 may store the program instructions on electrical-, magnetic- and/or optically-based storage media.

The image processor 120 (FIG. 1) and the central processor 710 (FIG. 7) may be provided in a variety of implementations. They can be embodied in integrated circuits, such as application specific integrated circuits, field programmable gate arrays, digital signal processors and/or general purpose processors.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A method, comprising:
performing image registration on a pair of images having at least a portion of image content in common;
warping a first image of the pair to a spatial domain of a second image of the pair based on the image registration;
generating a fused image from a blend of the warped first image and the second image, wherein relative contributions of the warped first image and the second image are weighted according to a distribution pattern based on a size of a smaller of the pair of images.

2. The method of claim 1, further comprising:
identifying a region of interest from one of the images;
when the region of interest is co-located with a spatial region occupied by the distribution pattern, altering the distribution pattern to increase contribution of one of the images in the areas the region of interest.

3. The method of claim 1, wherein the first image has higher resolution but a smaller field of view than the second image.

4. The method of claim 1, further comprising generating weights by:
detecting foreground content in one of the first and second images;
assigning weights to one of the images in which pixel locations associated with foreground content are assigned higher weights than pixel location not associated with foreground content.

5. The method of claim 4, wherein the image registration generates a pixel-wise confidence score indicating a degree of match between the pair of images at each pixel location, and the assigning weights occurs based on the confidence scores.

6. The method of claim 1, further comprising generating weights by:
detecting a region of interest from at least one of the first and second images;
assigning weights to one of the images in which pixel locations associated with the region of interest are assigned higher weights than pixel location not associated the region of interest.

7. The method of claim 1, wherein the generating is performed based on a transform-domain fusion technique.

8. The method of claim 1, wherein the generating is performed based on a spatial-domain fusion technique.

9. A device, comprising:
a pair of cameras, each having different properties from the other;
a processor to:
perform image registration on images output from each of the cameras in a common image capture event;
warp the image from the first camera to a spatial domain of the image from the second camera based on the image registration;
generate a fused image from a blend of the warped image and the second camera image, wherein relative contributions of the warped image and the second camera image are weighted according to a distribution pattern based on a size of a smaller of the pair of images.

10. The device of claim 9, further comprising:
a region of interest detector;
wherein, when the region of interest is co-located with a spatial region occupied by the distribution pattern, the processor alters the distribution pattern to increase contribution of one of the images in the areas the region of interest.

11. The device of claim 9, wherein the first camera image has higher resolution but a smaller field of view than the second camera image.

12. The device of claim 9, wherein the processor generates weights by:
detecting foreground content in one of the first and second camera images;
assigning weights to one of the images in which pixel locations associated with foreground content are assigned higher weights than pixel location not associated with foreground content.

13. The device of claim 9, wherein the processor generates weights by:
detecting a region of interest from at least one of the first and second images;
assigning weights to one of the images in which pixel locations associated with the region of interest are assigned higher weights than pixel location not associated the region of interest.

14. The device of claim 9, wherein the processor generates the fused image based on a transform-domain fusion technique.

15. The device of claim 9, wherein the processor generates the fused image based on a spatial-domain fusion technique.

16. A computer readable medium storing program instructions that, when executed by a processing device, causes the device to
perform image registration on a pair of images having at least a portion of image content in common;
warp a first image of the pair to a spatial domain of a second image of the pair based on the image registration;
generate a fused image from a blend of the warped first image and the second image, wherein relative contributions of the warped first image and the second image are weighted according to a distribution pattern based on a size of a smaller of the pair of images.

17. The medium of claim 16, wherein the instructions further cause the device to:
identify a region of interest from one of the images;
when the region of interest is co-located with a spatial region occupied by the distribution pattern, alter the distribution pattern to increase contribution of one of the images in the areas the region of interest.

18. The method of claim 1, wherein the first image has higher resolution but a smaller field of view than the second image.

19. The medium of claim 16, wherein the instructions further cause the device to generate weights by:
detecting foreground content in one of the first and second images;
assigning weights to one of the images in which pixel locations associated with foreground content are assigned higher weights than pixel location not associated with foreground content.

20. The method of claim 4, wherein the image registration generates a pixel-wise confidence score indicating a degree of match between the pair of images at each pixel location, and the assigning weights occurs based on the confidence scores.

21. The medium of claim 16, wherein the instructions further cause the device to generate weights by:
detecting a region of interest from at least one of the first and second images;
assigning weights to one of the images in which pixel locations associated with the region of interest are assigned higher weights than pixel location not associated the region of interest.

22. The medium of claim 16, wherein the generation of the fused image based on a transform-domain fusion technique.

23. The medium of claim 16, wherein the generation of the fused image is performed based on a spatial-domain fusion technique.
